(19) United States
(12) Patent Application Publication
(10) Pub. No.: US 2023/0034952 A1
(43) Pub. Date: Feb. 2, 2023

(54) Stretch-Release Adhesive Articles with a Pattern of Slits

(71) Applicant: 3M INNOVATIVE PROPERTIES COMPANY, St. Paul, CA (US)

(72) Inventors: Chaodi Li, Woodbury, MN (US); Yuzhi Xia, Woodbury, MN (US); Bret W. Ludwig, Oakdale, MN (US); Dylan T. Cosgrove, Oakdale, MN (US); Michael J. Wald, Woodbury, MN (US); Abbi G. Johnson, Hudson, WI (US); Christina D. Cowman-Eggert, Inver Grove Heights, MN (US)

(21) Appl. No.: 17/789,644

(22) PCT Filed: Dec. 28, 2020
(86) PCT No.: PCT/IB2020/062489

§ 371 Date: Jun. 28, 2022

Related U.S. Application Data
(60) Provisional application No. 62/955,887, filed on Dec. 31, 2019.

(51) Int. Cl. B32B 7/12; B32B 27/06; B32B 27/30

(52) U.S. Cl. CPC B32B 7/12; B32B 27/065; B32B 27/308; B32B 2405/00

(57) ABSTRACT

Stretch-release adhesive articles with tunable mechanical properties are provided. The articles include a stretchable carrier extending along a first direction and including a first major surface and a second major surface opposite the first major surface. At least one of the first and second major surfaces of the stretchable carrier is a stretch-releasable adhesive surface, and the stretchable carrier includes a pattern of slits distributed thereon and configured to deform upon a stretch on the stretchable carrier to elongate the stretchable carrier.

### FIELD

The present disclosure generally relates to adhesive articles and, more particularly, to stretch-releasable adhesive articles and methods.

### BACKGROUND

Stretch-release adhesive tapes are widely used for permanent or temporary bond applications. It can remove cleanly and easily by stretching the adhesive at certain degree angles without damage or residue.

### SUMMARY

In one aspect, the present disclosure describes a stretch-releasable adhesive article including a stretchable carrier extending along a first direction and including a first major surface and a second major surface opposite the first major surface. At least one of the first and second major surfaces of the stretchable carrier is a stretch-releasable adhesive surface, and the stretchable carrier includes a pattern of slits distributed thereon and configured to deform upon a stretch on the stretchable carrier to elongate the stretchable carrier.

In another aspect, the present disclosure describes a method of making a stretch-releasable adhesive tape. The method includes providing a stretchable carrier, the stretchable carrier extending along a first direction and including a first major surface and a second major surface opposite to the first major surface; providing one or more stretch-releasable adhesive surfaces on at least one of the first and second major surfaces of the stretchable carrier; and providing a pattern of slits distributed on the stretchable carrier, the slits each configured to deform upon a stretch on the stretchable carrier to elongate the stretchable carrier.

Various unexpected results and advantages are obtained in exemplary embodiments of the disclosure. One such advantage of exemplary embodiments of the present disclosure is to obtain stretchable materials or films with higher failure strength, even for articles or films of stiff materials. The embodiments also provide a wide range of films with precisely controlled mechanical responses via micro-structured designs, i.e., various patterns of cuts or slits on the articles or films. The embodiments described herein provide fine tuning of the mechanical responses of stretched film during stretching release. Such a fine tuning produces strain-hardening mechanical response characteristic that provides wider regions with more uniformed strain fields during stretching release, which can prevent sudden breaking of stretched film in the necking region (near the debonding front) due to high stress concentration. With a pattern of slits on the film, a broad range of film materials can be used for stretching release applications, removing the constrains of material selections. In the current stretching film development, only particular films that having distinct mechanical characteristics (such as strain-hardening) are appropriate, mainly determined by chemical compositions to achieve such mechanical characteristics.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1A is a cross-sectional side view of an adhesive article, according to one embodiment.

FIG. 1B is a cross-sectional side view of the adhesive article of FIG. 1A in use, according to one embodiment.

FIG. 1C is a plan view of the adhesive article of FIG. 1B, according to one embodiment.

FIG. 2 is a cross-sectional side view of an adhesive article, according to another embodiment.

FIG. 3 is a plan view of an adhesive article, according to another embodiment.

FIG. 4A is a schematic plan view of an adhesive article where a pattern of slits has a geometrical arrangement of micro-structured unit cells, according to one embodiment.

FIG. 4B is an enlarged portion view of FIG. 4A.

FIG. 4C is a force-displacement curve of the stretchable carrier of FIG. 4A.

FIG. 5A illustrates a unit cell pattern of a stretchable carrier, according to one embodiment.

FIG. 5B illustrates a schematic plan view of a unit cell pattern of a stretchable carrier, according to another embodiment.

FIG. 5C illustrates a schematic plan view of a unit cell pattern of a stretchable carrier, according to another embodiment.

FIG. 5D illustrates a schematic plan view of a unit cell pattern of a stretchable carrier, according to another embodiment.

FIG. 5E illustrates a schematic plan view of a unit cell pattern of a stretchable carrier, according to another embodiment.

FIG. 5F illustrates a schematic plan view of a unit cell pattern of a stretchable carrier, according to another embodiment.

FIG. 6A illustrates a schematic plan view of a stretchable carrier having the pattern of FIG. 5A without stretch.

FIG. 6B illustrates a schematic plan view of the stretchable carrier of FIG. 6A under stretch.

FIG. 7A illustrates a schematic plan view of a stretchable carrier having the pattern of FIG. 5F without stretch.

FIG. 7B illustrates a schematic plan view of the stretchable carrier of FIG. 7A under stretch.

FIG. 8 illustrates stress versus strain curves for Examples with a pattern of slits and Comparative Example without slits.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

Stretch-releasable adhesive articles with tunable mechanical properties are provided. The articles include a stretchable carrier where a pattern of slits is distributed thereon and configured to deform upon a stretch on the stretchable carrier to provide desired mechanical properties.

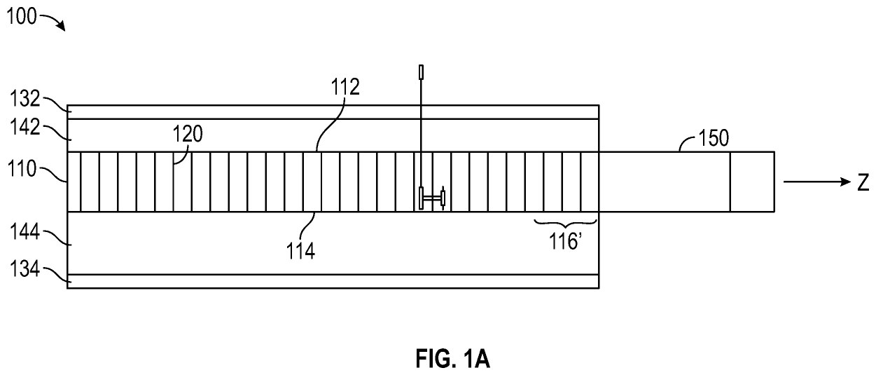

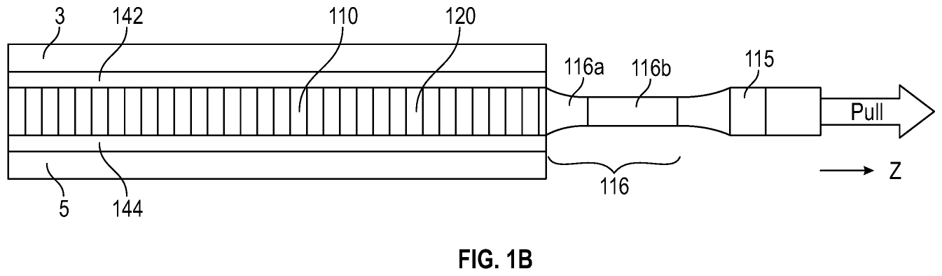

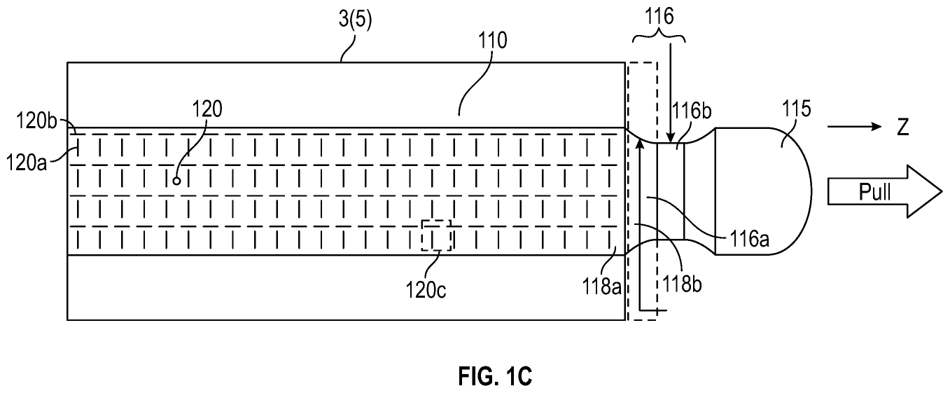

FIG. 1A is a cross-sectional side view of an adhesive article 100, according to one embodiment. The adhesive article 100 includes a stretchable carrier 110 extending along a longitudinal direction as indicated by the Z axis and including a first major surface 112 and a second major surface 114 opposite the first major surface 112. At least one of the first and second major surfaces 112 and 114 is a stretch-releasable adhesive surface. In the depicted embodiment of FIG. 1A, adhesive layers 142 and 144 of the same or different adhesive compositions are provided on opposite major surfaces 112 and 114 of the stretchable carrier 110. The adhesive layers 142 and 144 are respectively covered by release liners 132 and 134. The stretchable carrier 110 extends farther longitudinally than the adhesive layers 142 and 144 to form a tab 115 to facilitate the stretch release of the adhesive article 100 when the stretchable carrier 110 is pull along the longitudinal direction Z.

The stretchable carrier 110 includes a pattern of slits 120 distributed thereon and configured to deform upon a stretch on the stretchable carrier 110 to elongate the stretchable carrier 110 in the longitudinal direction as indicated by the Z axis. FIG. 1B is a cross-sectional side view of the adhesive article 100 of FIG. 1A under a stretch via a pull force 8 along the longitudinal direction. FIG. 1C is a plan view of the adhesive article 100 of FIG. 1B under the stretch force 8.

In the exemplary embodiment depicted in FIG. 1C, the pattern of slits 120 includes a first set of slits 120a each extending along a lateral direction substantially perpendicular to the longitudinal direction, and a second set of slits 120b each extending along a direction substantially parallel to the longitudinal direction. As shown in FIG. 1B, at least some of the slits 120a or 120b are through cuts. In other words, at least some of the slits 120 extend through the thickness of the stretchable carrier 110.

The pattern of slits described herein can be formed by at least partially cutting through the bulk of the carrier in its thickness direction. In some embodiments, a pattern of slits can be formed on a carrier by a die-cutting process, where a die plate or rotary tool having a pattern machined into its face can be used as a cutting feature to engage with the substrate surface (e.g., the carrier) to form a pattern of slits thereon. The cutting features may have different dimensions to make a through-cut or a partial-cut into the carrier.

The stretchable carrier may have a single layer or multilayer structure. The stretchable carrier may include, for example, one or more polymeric foams, one or more polymeric films, various viscoelastic materials, stiff materials, etc. In some embodiments, the carrier may have a thickness of, for example, between about 10 micrometers and about 5 mm. In some embodiments, the carrier may have a thickness of between about 10 mils and about 30 mils. In some embodiments, the pattern of slits can be formed onto a core layer of the stretchable carrier, which can then be laminated with one or more continuous polymeric films or foams.

The stretchable carrier 110 can include any suitable material that allows the carrier 110 being stretchable along its longitudinal direction. In some embodiments, the carrier 110 can include one or more viscoelastic core layers. The term “viscoelastic” or “viscoelasticity” relates to the amount of force that is relaxed by the material over time. In the present application, this relaxation is measured by, for example, compression stress relaxation. Generally, in that test, a force probe is placed in the sample until it measures a specific force. The probe is then held at that depth and how the force changes with time is measured. Some embodiments relax significantly with time. In some embodiments that relate to applying an adhesive to a rough surface, viscous flow is preferred to enable good contact and also maintaining the adhesive contact over time. For example, a material that is very elastic but very soft might have initially good wetout but, over time, the material may “spring back” and lose its wetout with time, since it can't relax internal stress through viscous flow. WO 2017/136280 (Cowman-Eggert et al.) describes various carriers including a single layer or a multilayer construction, which is incorporated herein by reference.

The stretchable carrier described herein can assist the adhesive article in conforming to the surface of the adherend. In some embodiments, the carrier and/or adhesive article may have a compression stress relaxation (CSR) between about 10% and about 100% after 10 seconds as measured by texture analysis. In some embodiments, the core layer and/or adhesive article may have a compression stress relaxation (CSR) between about 10% and about 80% after 10 seconds as measured by texture analysis. The stress relaxation of the carrier and/or adhesive article permits more force to be applied through the stretch release adhesive tape when a user is applying the tape to the surface of an adherend. In some embodiments, the stretchable carrier may have a lengthwise elongation at break of, for example, from about 50% to about 1200%. In some embodiments, the stretchable carrier may have a tensile strength at break sufficiently high so that the multilayer carrier will not rupture prior to being stretched and removed from an adherend. The carrier may have an elastic recovery of about 0% to 50% after release of the adhesive article from an adherend.

The carrier can include any components that permit it to have the desired properties. For example, in some embodiments, the carrier may include (meth)acrylic (co)polymers made by various polymerization techniques including but not limited to solvent polymerization, dispersion polymerization, solventless bulk polymerization, and radiation polymerization, including processes using ultraviolet light, electron beam, and gamma radiation. The monomer mixture may comprise a polymerization initiator, especially a thermal initiator or a photoinitiator of a type and in an amount effective to polymerize the comonomers. In some embodiments, the carrier may include an acrylic that has been or can be crosslinked. The core layer may be crosslinked through the addition of crosslinkable monomers. The core layer may comprise a single crosslinking monomer, or a combination of two or more crosslinking monomers.

Some exemplary desired properties of the carrier may include viscoelasticity, storage modulus, loss modulus, glass transition temperature, and/or good wetout. In some embodiments, the carrier may have an effective storage modulus of, for example, between about 15×10³ Pa and about 2.5×10⁶ Pa at 25 degrees Celsius. In some embodiments, the carrier may have a tan δ (where tan δ is the loss modulus divided by the storage modulus) of between about 0.4 and about 1.2 at 25 degrees Celsius. In some embodiments, the carrier may have a glass transition temperature of between about −125 and about 40 degrees Celsius. The carrier may have a stress relaxation between 5% and 100% after 10 s. In other embodiments, the core layer has a stress relaxation between 10% and 100% after 10 seconds.

It is to be understood that in some embodiments, a stretchable carrier described herein can be made of one or more stiff materials where the pattern of slits thereon can make the carrier material stretchable which is otherwise “stiff.” In other words, the films with a pattern of slits can generate highly stretchable characteristic that exhibits highly nonlinear stress-strain behaviors resulting from the pattern of slits rather than their constituent materials alone. While not wanting to be bound by theory, it is believed that the underlying mechanisms is largely accommodated by the bending and rotation of the pattern of slits during stretching. The slit film can reduce stiffness by a factor of, for example, about 100 while increasing ultimate strain by, for example, a factor of about 10 (i.e., larger effective elongation limits). With slit designs described herein, it results in releasing some constraints for regular films without slits, including, for example, failure strain limit and strain-hardening characteristics, for stretching carrier. In many embodiments described herein, the carrier or film materials in slit designs can be selected from any general materials, including, for example, non-stretchable/low stretchable materials and/or stretchable materials, for example, copy paper, copper (Cu), Aluminum foil, and polymeric materials (such as Polyethylene Terephthalate, Poly-dimethyl siloxane, etc.). In some embodiments, the carriers or films may include a single material, or a combination of two or more materials. In some embodiments, the films can be a single layer, or a multilayer laminate of suitable materials.

While the embodiment depicted in FIG. 1A shows separate adhesive layers, it is to be understood that in some embodiments, the carrier 110 itself may be an adhesive. In some embodiments, the carrier may be a pressure sensitive adhesive. In some embodiments, the carrier may fulfill the Dahlquist criterion for pressure-sensitive tack. The Dahlquist criterion for pressure-sensitive tack is defined as an adhesive formulation that possesses a modulus of not more than 3×10⁵ Pa at 25° C. at 1 Hz (A.V. Pocius in “Adhesives and Adhesion Technology”, 3rd Ed. 2012, Hanser Publications, Cincinnati, Ohio; also referenced in US 2011/0179549, U.S. Pat. Nos. 7,605,212, and 5,719,247). The Dahlquist criterion for pressure sensitive tack is also described as 1 sec compliance of a typical pressure-sensitive adhesive to be 10⁶ cm²/dyne (D.A. Satas (ed.) in “Handbook of Pressure-Sensitive Adhesive Technology” 1982, Van Nostrand Reinhold Company Inc. New York, N.Y.)

In some embodiments, the adhesive articles described herein may exhibit a shear strength of greater than 1800 minutes, or greater than 10,000 minutes as measured according to ASTM D3654-82. In some embodiments, the adhesive articles may exhibit stretch debonding of between about 20 and about 170 oz/0.625 inch (oz/0.625 inch=17.86 g/cm), or between about 45 and about 80 oz/0.625 inch (oz/0.625 inch=17.86 g/cm).

In some embodiments featuring either one or both of stretch and peel release adhesives, the adhesive layer 142 or 144 or the major surface(s) of the carrier 110 can be a pressure sensitive adhesive. A general description of useful pressure sensitive adhesives may be found in the Encyclopedia of Polymer Science and Engineering, Vol. 13, Wiley-Interscience Publishers (New York, 1988). Additional description of useful pressure-sensitive adhesives may be found in the Encyclopedia of Polymer Science and Technology, Vol. 1, Interscience Publishers (New York, 1964). Any suitable composition, material or ingredient can be used in the pressure sensitive adhesive. Exemplary pressure sensitive adhesives utilize one or more thermoplastic elastomers, e.g., in combination with one or more tackifying resins. In some embodiments, the adhesive is not a pressure sensitive adhesive.

Some exemplary stretch releasable adhesives that can be used in the adhesive articles described herein include, for example, those described in U.S. Pat. No. 6,569,521 or International Publications WO/2017/136188, WO/2017/136219, or US Publication No. 2016/0068722, each of which is incorporated herein by reference in its entirety. In some embodiments, the adhesive layer includes one or more hydrocarbon block copolymers; and a polar phenolic tackifier comprising a phenolic moiety and having a hydroxyl value of between 20 to 130 and an acid value of less than 0.5. In some embodiments, the adhesive includes at least one of the polar phenolic tackifiers is a terpene phenol.

Some stretch releasable adhesives that can be used in the adhesive articles of the present disclosure have a glass transition temperature of about −125° C. to 20° C., as determined by dynamic mechanical analysis of the tan δ peak value. Some stretch releasable adhesives that can be used in the adhesive articles of the present disclosure have a storage modulus of about 400,000 Pa or less, or 300,000 or less at 25° C., as determined by dynamic mechanical analysis.

In some embodiments, the thickness of the stretch releasable adhesive on at least one of the first or second major surfaces of the carrier is about 1 micrometer to about 1 mm.

In some embodiments, the stretch releasable adhesives are tailored to achieve removal with no or minimal damage. Exemplary methods and articles for doing so are described in, for example, U.S. Pat. No. 6,835,452 and International Application Number (assigned to the present assignee) PCT/US2017/048654, each incorporated herein by reference in its entirety.

In embodiments featuring peelable adhesive layers, the peelable adhesive can be, for example, any of the adhesives described in any of the following patent applications, all of which are incorporated by reference herein: International Publication Nos. WO/2015/035556, WO/2015/035960, WO/2017/136219, WO/2017/136188 and U.S. Patent Application No. 2015/034104, all of which are incorporated herein by reference in their entirety.

In some embodiments, the peelable adhesive layer can include at least one of rubber, silicone, or acrylic based adhesives. In some embodiments, the peelable adhesive can include tackified rubber adhesives, such as natural rubber; olefins; silicones, such as silicone polyureas or silicone block copolymers; synthetic rubber adhesives such as polyisoprene, polybutadiene, and styrene-isoprene-styrene, styrene-ethylene-butylene-styrene and styrene-butadiene-styrene block copolymers, and other synthetic elastomers; and tackified or untackified acrylic adhesives such as copolymers of isooctylacrylate and acrylic acid, which can be polymerized by radiation, solution, suspension, or emulsion techniques; polyurethanes; silicone block copolymers; and combinations of the above.

Generally, any known additives useful in the formulation of adhesives, stretch releasable or peelable, may also be included. Additives include plasticizers, anti-aging agents, ultraviolet stabilizers, colorants, thermal stabilizers, anti-infective agents, fillers, crosslinkers, as well as mixtures and combinations thereof. In certain embodiments, the adhesive can be reinforced with fibers or a fiber scrim which may include inorganic and/or organic fibers. Suitable fiber scrims may include woven-, non-woven or knit webs or scrims. For example, the fibers in the scrim may include wire, ceramic fiber, glass fiber (for example, fiberglass), and organic fibers (for example, natural and/or synthetic organic fibers).

The external surfaces of the adhesive layers 142 and 144 can be used to affix the adhesive article 100 to the desired adherend, hardgoods, and/or mounting object (e.g., a picture frame). FIGS. 1B and C illustrate that the adhesive layers 142 and 144 are affixed to objects 3 and 5, respectively. When a user pulls the tab 115 to stretch the carrier 110 at the direction 8, the adhesive layers 142 and 144 can gradually debond from the adherend when the carrier 110 is stretched substantially parallel to the adherend surface. The portion 116′ of the carrier 110 originally adjacent to the tab 115 as shown in FIG. 1A can be stretched, flow out of the region originally covered by the adhesive layers 132 and 134, and become a stretched, deformed, and debonded portion 16 as shown in FIGS. 1B-C. The stretched portion 116 forms an in-process hardening zone 116a and a hardened zone 116b. The carrier 110 may recoil after the removal of the stretch force.

While not wanting to be bound by theory, the present disclosure found that the carrier 110 transfers sufficient force to the un-deboned region during release to continue deformation and release at the debond front. As shown in FIG. 1C, the line 118a is the debond front. The region as indicated by the dash box 118b on the right side of the debond front 118a has been deboned while the region on the left side of the debond front 118a is still un-debonded. When the force required to continue stretching the debonded portion 16 of the carrier is lower than the force to debond, the debonded region 16 may continue to deform which may result in premature breaking of the stretching carrier. To achieve the desired physical properties, the stretchable carrier 110 may be made of multilayer films designed to have a strain-hardening response. The strain-hardening region in common polymers may only happen at high degrees of strain, for example stretch ratio higher than 400%. Such significant stretch may result in hazardous spring back after force removal.

To release a stretch release film, it is helpful to control the strain balance (e.g., strain uniformity) during debonding progress. It has been found that the carrier in the de-bonding region is loaded with increased stress due to stress concentration near the debonded front that may resulting in necking. A carrier may highly deform in the absence of strain-hardening properties described herein. For a conventional carrier, its stress-strain curve may be determined by the mechanical properties of the carrier material. It is usually challenging to find suitable strain-hardening carrier/film with proper strain level for stretch release. A lot of developments have been performed to adjust particular film formulations and constructions. The operation windows with such methods are very limited.

For carriers with strain-hardening characteristics described in this disclosure, it has been found that the carrier can provide substantial force (stress) to lengthen the carrier in the deboned regions. It has been shown in the present disclosure that stretching carriers/films with strain-hardening characteristic can lead to better strain uniformity and resulting in better force transfer from the debonded region to the un-debonded region. The embodiments described herein provide unique mechanical response characteristics. In other words, films can be soft, highly stretchable (larger plateau region) and reaching final regime of strain-hardening response. The embodiments described herein provide methodologies to directly and efficiently control the film mechanical responses without modifying the chemical compositions. The methodologies can be applied to a broad range of film materials including, for example, various viscoelastic or stiff materials. For example, there is no need for the individual film to have strain-hardening region in its mechanical responses. Especially, the stress-strain responses can be properly and efficiently controlled with the methodologies described herein.

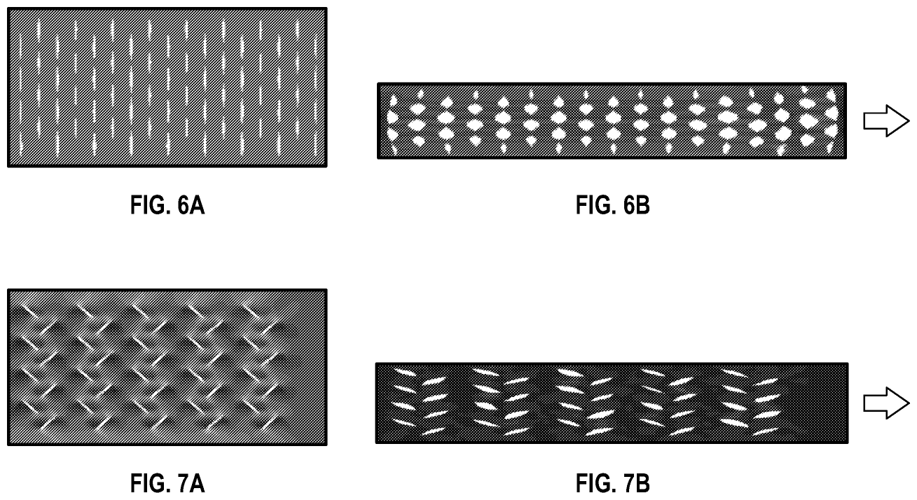

The pattern of slits 120 on the stretched portion 116 can deform upon the stretch on the carrier 110. As shown in FIGS. 6B and 7B, slits each may deform to an opening upon the stretch. The deformed slits in the stretched portion 116 are not shown in FIGS. 1B and 1C for simplicity.

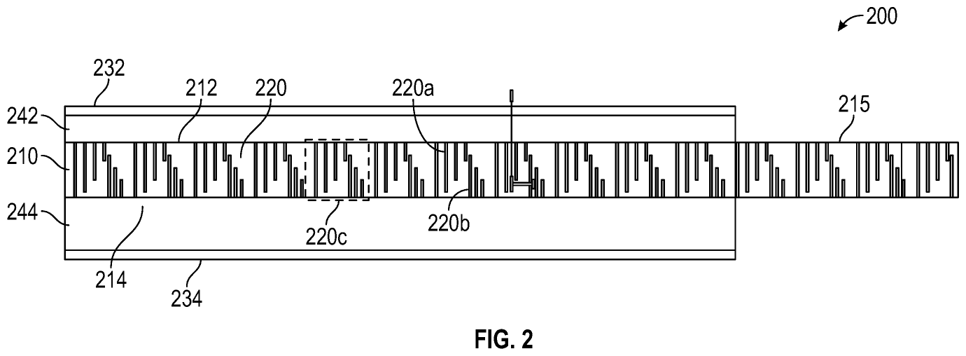

FIG. 2 is a cross-sectional side view of an adhesive article 200, according to another embodiment. The adhesive article 200 includes a stretchable carrier 210 extending along a longitudinal direction and including a first major surface 212 and a second major surface 214 opposite the first major surface. At least one of the first and second major surfaces 212 and 214 is a stretch-releasable adhesive surface. In the depicted embodiment of FIG. 2, adhesive layers 242 and 244 of the same or different adhesive compositions are provided on opposite major surfaces 212 and 214 of the stretchable carrier 210. The adhesive layers 242 and 244 are respectively covered by release liners 232 and 234. The stretchable carrier 210 extends farther longitudinally than the adhesive layers 242 and 244 to form a tab 215 to facilitate the stretch release of the adhesive article 200.

The stretchable carrier 210 includes a pattern of slits 220 distributed thereon and configured to deform upon a stretch on the stretchable carrier 210 to elongate the stretchable carrier in the longitudinal direction. The pattern of slits 220 includes a first set of slits 220a each extending from the first major surface 212 into the carrier 210 along the thickness direction, and a second set of slits 220b each extending from the second major surface 214 into the carrier 210 along the thickness direction. The slits 220 each partially extend into the carrier 210. In other words, the slits 220a each does not reach the opposite surface 214 and the slits 220b each does not reach the opposite surface 212.

It is to be understood that a carrier such as the carrier 110 or 210 may have a multilayer structure. For example, a carrier may include a core layer and one or more polymeric layer disposed on one or both sides of the core layer. In some embodiments, a pattern of slits can be formed on the core layer by at least partially extending into the core layer. Then the one or more polymeric layer can be laminated on the core layer to form a stretchable carrier.

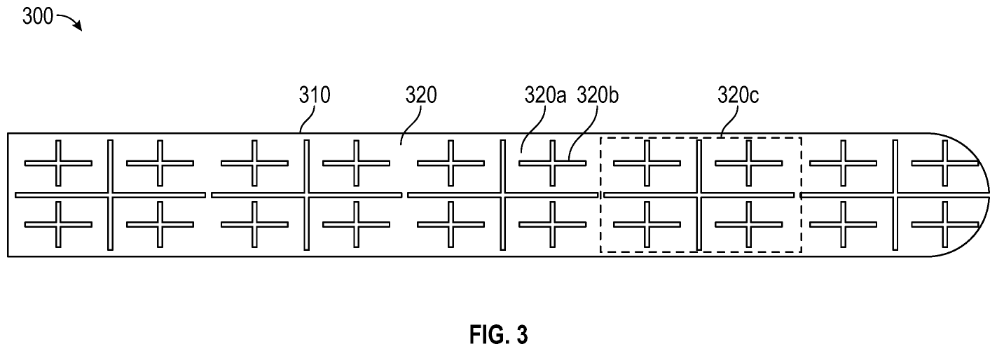

FIG. 3 is a plan view of an adhesive article 300, according to another embodiment. The adhesive article 300 includes a stretchable carrier 310 where a pattern of slits 320 are distributed thereon. The pattern of slits 320 has a hierarchical structure by including a set of larger slits 320a and a set of smaller slits 320b. Each larger slit 320a is grouped with a group of smaller slits 320b. In the depicted embodiment of FIG. 3, the slits 320 each have a cross shape. The larger slits 320a may have a dimension, for example, at least 2 times, 3 times, 4 times or 5 times greater than the smaller slits 320b.

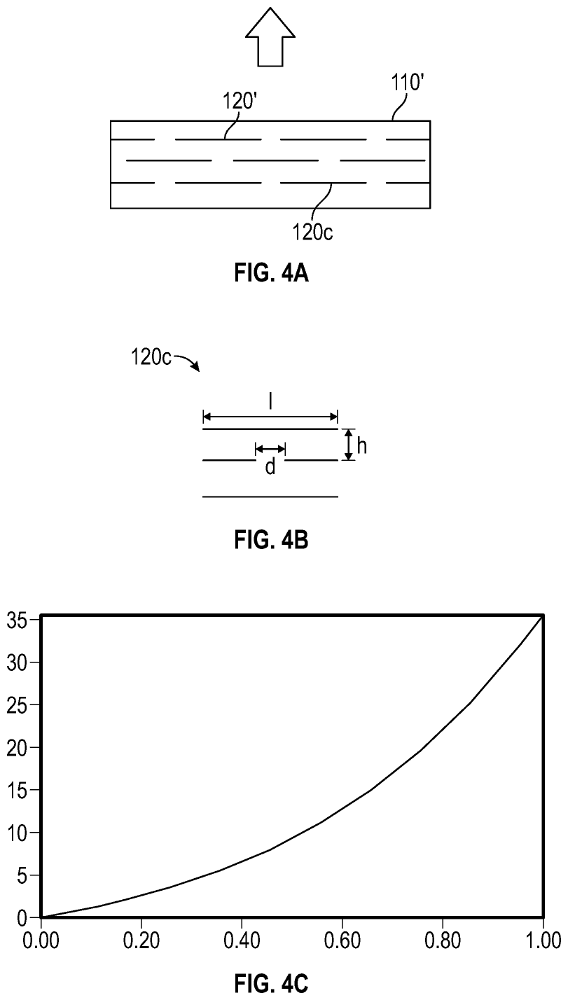

In some embodiments, a pattern of slits distributed on a stretchable carrier, such as, for example, the pattern 120, 220 and 320, may have a geometrical arrangement of micro-structured unit cells. FIG. 4A is a schematic plan view of an adhesive article where a pattern of slits 120′ on a stretchable carrier 110′ has an exemplary geometrical arrangement of micro-structured unit cells 120c. FIG. 4B illustrates one unit cell 120c including a pattern of slits substantially perpendicular to the longitudinal direction (as shown by the arrow in FIG. 4A) of the carrier 110′. For each unit cell, there are multiple design parameters including, for example, the cut length l, the distance between two adjacent cuts d, and the distance between two cut lines h. In some embodiments, the cut length l may be in the range of, for example, from 0.05 mm to 100 mm, from 0.1 mm to 50 mm from, from 0.2 mm to 10 mm, or from 0.2 mm to 5 mm. The cut width of a slit under an unstretched state may be, for example, at least 10 times, 20 times, 30 times, or 50 times less than the cut length l. The distance between two adjacent cuts d, may be in the range of, for example, from 0.01 mm to 20 mm, from 0.05 mm to 10 mm, from 0.1 mm to 2 mm, or from 0.2 mm to 1 mm. The distance between two cut lines h may be in the range of, for example, from 0.1 mm to 2 mm. It is to be understood that the design parameters of the unit cell may have various ranges, depending on the desired applications.

The present disclosure found that the geometrical configuration of a unit cell may attribute to the mechanical behavior characteristics of the adhesive. The unit cell parameters can be applied to adjust the properties of the adhesive articles described herein, by designing materials and structures with tailorable and nonlinear mechanical properties. The unit cell may include various shapes of cuts, including, for example, straight lines, curves, square cut unit, etc. With different slit patterns, the carriers or films can provide large diversities of mechanical responses characteristics and deformed shapes.

Simulation methods are applied to carriers including various patterns of slits and/or made of different types of materials, including both linear elastic and hyperelastic materials, to achieve distinct characteristic mechanical properties for stretching release articles described herein. As shown in FIG. 4C as an example, the force-displacement curve of the stretchable carrier 110′ of FIG. 4A with linear elastic properties may present highly nonlinear stress-strain response including strain-hardening region. The strain-hardening region can be controlled by layer construction (e.g., individual layer thickness), material properties, micro-structured unit designs (slit density, shape, etc.), or the combination thereof. Strain hardening behavior is related to the critical buckling force of the unit cell. The critical buckling force F_{cr} can be obtained using equation (1) as follow:

$${F}_{cr} = 4.62 π \sqrt{\frac{ρ}{2 ( 1 + v )}} \frac{Eht \text{?}}{( l - d ) \text{?}} . \qquad ( 1 )$$

$$\text{?} \text{indicates text missing or illegible when filed}$$

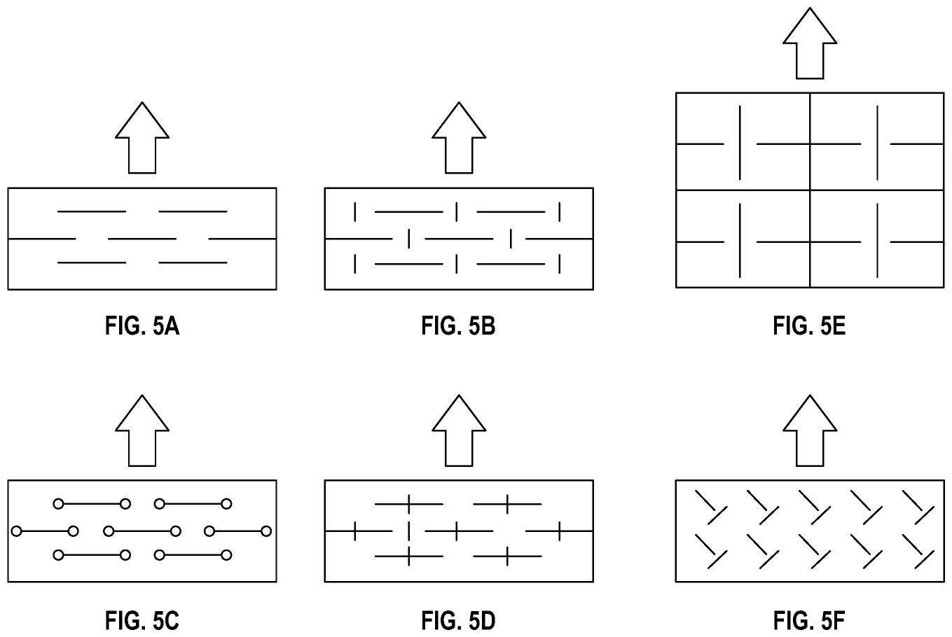

Unit cell design with long cut and high cutting density on a stretchable carrier may provide the mechanical response when significant strain-hardening behavior may be desirable. FIGS. 5A-F illustrate different unit cell patterns designed to achieve the specific mechanical responses for stretching adhesive articles. The longitudinal directions of the respective stretchable carriers are shown by the arrows.

As shown in FIG. 5A, the slits include an array of transverse cuts substantially perpendicular to the longitudinal direction. As shown in FIG. 5B, the slits include an array of transverse cuts each substantially perpendicular to the longitudinal direction and an array of longitudinal cuts substantially parallel to the longitudinal direction. The transverse cuts are longer than the longitudinal cuts. The present disclosure found that the addition of longitudinal cuts (e.g., the pattern in FIG. 5B versus FIG. 5A) may significantly modify the deformation behavior of the slit stretching film, resulting in a lower stiffness comparing to that of transverse major cuts only (FIG. 5A). The longitudinal cuts may also increase the ultimate extensibility of the stretchable carriers or films.

As shown in FIG. 5C, the slits include an array of transverse cuts substantially perpendicular to the longitudinal direction. Each cut/slit further includes adding additional holes at the opposite ends there. While not wanting to be bound by theory, it is believed that the holes at the opposite ends may help to release the crack-tip stress at both ends of slits and prevent pre-mature crack propagations at the ends of the slits. As shown in FIG. 5D, the slits include an array of cross shaped cuts. As shown in FIG. 5E, the slits include an array of cross shaped cuts arranged in a hierarchical structure similar to the pattern in FIG. 3. As shown in FIG. 5F, the slits include two arrays of slant cuts substantially orthogonal with each other. The slant cuts each extends in a direction oblique to the longitudinal direction. In other words, the slant cuts each has a transverse component and a longitudinal component.

Finite-element models were generated to study and define slitting geometries. The commercial finite element modeling Software, Abaqus CAE/Standard 2019 by Simulia, Dassault Systems (Paris, France) was utilized to perform the calculations. Three-dimensional elements were used to define the deformable structures. Slits were defined as seams in Abaqus CAE to allow the material to open up, thereby modifying the global stress and strain response. The model to represent the tested material mechanical responses used a constitutive model of the film material defined as a second-order polynomial best fit to tension measurements for a hyperelastic material. The model was displacement controlled with extension along the X-axis to 600% total engineering strain, while being free to deform in other axes. An appropriate mesh seed size was chosen for individual geometries to balance computational accuracy and speed to solution. The models were executed in a High Performance Computing Environment on the 3M campus in Saint Paul, Minn.

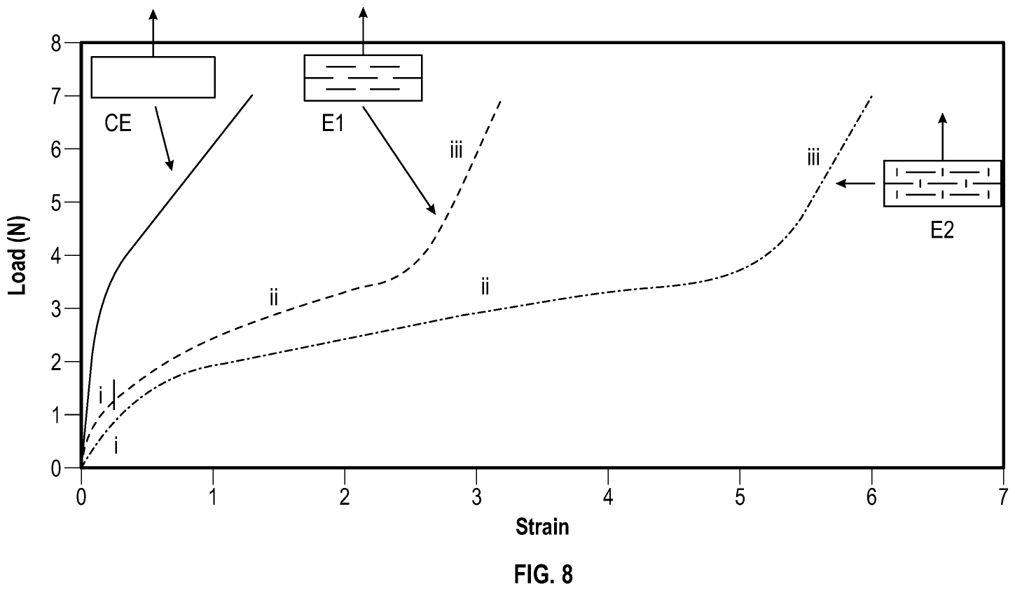

In the simulations, the effects of slit patterns (unit cell) on stretched film responses were parametrically investigated. The deformation shapes for a stretchable carrier with the unit cell of FIG. 5A before and after stretching are shown in FIGS. 6A and 6B, respectively. The deformation fields for another stretchable carrier with the unit cell of FIG. 5F before and after stretching are shown in FIGS. 7A and 7B, respectively. The stretching was along the longitudinal direction as indicated by the arrow. In the numerical studies, various design parameters were evaluated, including slit orientations (transverse, longitudinal or angled/slant), slit density, lined slit versus curved slit, etc. All the numerical studies were performed with Finite Element simulations. There are significant beam bending and rotation with slit designs comparing to regular film without slits during stretching, which can lead to significant elongation range (strain-softening) and strain-hardening at the final stage, as to be further described below for FIG. 8.

The mechanical responses of the slit structure can be adjusted with the slit designs, for example, by modifying the dimensional parameters listed above. The slit structure can tune the rigidity and breaking strain with the density of cuts in the structure. For example, the higher the slit density, the softer and the higher stretchability.

FIG. 8 illustrates stress versus strain curves for Example 1 (E1), Example 2 (E2) and Comparative Example (CE). The unit cells for Example 1 (E1), Example 2 (E2) and Comparative Example (CE) are shown in the inset of FIG. 8. Example 1 (E1), Example 2 (E2) and Comparative Example (CE) are the same carrier film except for with or without a pattern of slits. Example 1 (E1) has a pattern of slits as shown in FIG. 5A. Example 2 (E2) has a pattern of slits as shown in FIG. 5B. Comparative Example (CE) has no slits thereon. The stress-strain curves for E1 and E2 each include three regimes, i.e., (i) the initial regime which is similar to CE, (ii) the second soft regime (a plateau region), and (iii) the final hardening regime. Principles of stress-strain curves are explained in Isoba et al, 2016, Initial rigid response and softening transition of highly stretchable kirigami sheet materials, Scientific Reports, DOI: 10.1038/srep24758. In the initial regime (i), in-plane deformation is dominate. In the regimes (ii) and (iii), out-of-plane deformation and bending (without and with rotation) lead to characteristics of strain-softening and strain-hardening responses. As shown in FIG. 8, Comparative Example (CE) having no slits may fail in small elongation. For E1 and E2, each carrier film can sustain larger elongation. For E1 and E2, the plateau region in the regime (ii) reflects that strain-hardening occurs in carrier film's mechanical response that can provide uniformed strain during stretching and prevent pre-mature failure of stretching film near the peel front and the necking regions. By modifying the slit designs, different elongation limit and force level can be adjusted.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Exemplary embodiments of the present disclosure may take on various modifications and alterations without departing from the spirit and scope of the present disclosure. Accordingly, it is to be understood that the embodiments of the present disclosure are not to be limited to the following described exemplary embodiments, but is to be controlled by the limitations set forth in the claims and any equivalents thereof

### Listing of Exemplary Embodiments

Exemplary embodiments are listed below. It is to be understood that any one of embodiments 1-15 and 16-26 can be combined.

Embodiment 1 is a stretch-releasable adhesive article comprising:

a stretchable carrier extending along a first direction and including a first major surface and a second major surface opposite the first major surface,

wherein at least one of the first and second major surfaces of the stretchable carrier is a stretch-releasable adhesive surface, and

wherein the stretchable carrier includes a pattern of slits distributed thereon and configured to deform upon a stretch on the stretchable carrier to elongate the stretchable carrier.

Embodiment 2 is the stretch-releasable adhesive article of embodiment 1, further comprising a tab disposed at one end of the stretchable carrier to facilitate a stretch release.
Embodiment 3 is the stretch-releasable adhesive article of embodiment 2, wherein the tab includes an extension of the stretchable carrier.
Embodiment 4 is the stretch-releasable adhesive article of any one of embodiments 1-3, wherein the stretchable carrier includes a polymeric foam, a polymeric film, or a combination thereof.
Embodiment 5 is the stretch-releasable adhesive article of any one of embodiments 1-4, wherein the stretchable carrier has a lengthwise elongation at break of from about 50% to about 1200%.
Embodiment 6 is the stretch-releasable adhesive article of any one of embodiments 1-5, wherein the stretch-releasable adhesive surface includes a first stretch-releasable adhesive layer disposed on at least a portion of the first major surface of the stretchable carrier and a second stretch-releasable adhesive layer disposed on at least a portion of the second major surface.
Embodiment 7 is the stretch-releasable adhesive article of any one of embodiments 1-6, wherein the pattern of slits includes an array of slits each extending along a direction substantially perpendicular to the first direction.
Embodiment 8 is the stretch-releasable adhesive article of embodiment 7, wherein the slits each deforms to an opening on the stretchable carrier upon the stretch.
Embodiment 9 is the stretch-releasable adhesive article of embodiment 7 or 8, wherein the slits each includes a pair of holes at opposite ends of the respective slits.
Embodiment 10 is the stretch-releasable adhesive article of any one of embodiments 1-9, wherein the pattern of slits includes an array of slits each extending along a direction substantially parallel to the first direction.
Embodiment 11 is the stretch-releasable adhesive article of any one of embodiments 1-10, wherein the pattern of slits includes a plurality of slit unit cells in a periodic arrangement.
Embodiment 12 is the stretch-releasable adhesive article of any one of embodiments 1-11, wherein the pattern of slits includes one or more through slits each extending through the stretchable carrier in a thickness direction.
Embodiment 13 is the stretch-releasable adhesive article of any one of embodiments 1-12, wherein the pattern of slits includes one or more slits each extending partially into the stretchable carrier in a thickness direction.
Embodiment 14 is the stretch-releasable adhesive article of any one of embodiments 1-13, wherein the pattern of slits includes one or more slits each extending partially into the stretchable carrier from the first major surface and a second set of slits each extending partially into the stretchable carrier from the second major surface.
Embodiment 15 is the stretch-releasable adhesive article of any one of embodiments 1-14, wherein the pattern of slits includes a hierarchical structure.
Embodiment 16 is a method of making a stretch-releasable adhesive tape comprising:

providing a stretchable carrier, the stretchable carrier extending along a first direction and including a first major surface and a second major surface opposite to the first major surface, at least one of the first and second major surfaces of the stretchable carrier being a stretch-releasable adhesive surface; and

providing a pattern of slits distributed on the stretchable carrier, the slits each configured to deform upon a stretch on the stretchable carrier to elongate the stretchable carrier.

Embodiment 17 is the method of embodiment 16, further comprising providing a tab disposed at one end of the stretchable carrier to facilitate a stretch release of the stretch-releasable adhesive article from a substrate surface.
Embodiment 18 is the method of embodiment 17, wherein the tab includes an extension of the stretchable carrier.
Embodiment 19 is the method of any one of embodiments 16-18, wherein the stretchable carrier includes a polymeric foam, a polymeric film, or a combination thereof.
Embodiment 20 is the method of any one of embodiments 16-19, wherein the pattern of slits includes an array of slits each extending along a direction substantially perpendicular to the first direction.
Embodiment 21 is the method of embodiment 20, wherein the slits each deforms to an opening on the stretchable carrier upon the stretch.
Embodiment 22 is the method of any one of embodiments 16-21, wherein the pattern of slits includes an array of slits each extending along a direction substantially parallel to the first direction.
Embodiment 23 is the method of any one of embodiments 16-22, wherein the pattern of slits includes one or more through slits each extending through the stretchable carrier.
Embodiment 24 is the method of any one of embodiments 16-23, wherein the pattern of slits includes one or more slits each extending partially into the stretchable carrier.
Embodiment 25 is the method of any one of embodiments 16-24, wherein the pattern of slits includes a hierarchical structure.
Embodiment 26 is the method of any one of embodiments 16-25, wherein providing the pattern of slits comprises die-cutting the stretchable carrier.

Reference throughout this specification to “one embodiment,” “certain embodiments,” “one or more embodiments,” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment,” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments. While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. Furthermore, various exemplary embodiments have been described. These and other embodiments are within the scope of the following claims.

1. A stretch-releasable adhesive article comprising:
a stretchable carrier extending along a first direction and including a first major surface and a second major surface opposite the first major surface,
wherein at least one of the first and second major surfaces of the stretchable carrier is a stretch-releasable adhesive surface, and
wherein the stretchable carrier includes a pattern of slits distributed thereon and configured to deform upon a stretch on the stretchable carrier to elongate the stretchable carrier.

2. The stretch-releasable adhesive article of claim 1, further comprising a tab disposed at one end of the stretchable carrier to facilitate a stretch release.

3. The stretch-releasable adhesive article of claim 2, wherein the tab includes an extension of the stretchable carrier.

4. The stretch-releasable adhesive article of claim 1, wherein the stretchable carrier includes a polymeric foam, a polymeric film, or a combination thereof.

5. The stretch-releasable adhesive article of claim 1, wherein the stretchable carrier has a lengthwise elongation at break of from about 50% to about 1200%.

6. The stretch-releasable adhesive article of claim 1, wherein the stretch-releasable adhesive surface includes a first stretch-releasable adhesive layer disposed on at least a portion of the first major surface of the stretchable carrier and a second stretch-releasable adhesive layer disposed on at least a portion of the second major surface.

7. The stretch-releasable adhesive article of claim 1, wherein the pattern of slits includes an array of slits each extending along a direction substantially perpendicular to the first direction.

8. The stretch-releasable adhesive article of claim 7, wherein the slits each deforms to an opening on the stretchable carrier upon the stretch.

9. The stretch-releasable adhesive article of claim 7, wherein the slits each includes a pair of holes at opposite ends of the respective slits.

10. The stretch-releasable adhesive article of claim 1, wherein the pattern of slits includes an array of slits each extending along a direction substantially parallel to the first direction.

11. The stretch-releasable adhesive article of claim 1, wherein the pattern of slits includes a plurality of slit unit cells in a periodic arrangement.

12. The stretch-releasable adhesive article of claim 1, wherein the pattern of slits includes one or more through slits each extending through the stretchable carrier in a thickness direction.

13. The stretch-releasable adhesive article of claim 1, wherein the pattern of slits includes one or more slits each extending partially into the stretchable carrier in a thickness direction.

14. The stretch-releasable adhesive article of claim 1, wherein the pattern of slits includes one or more slits each extending partially into the stretchable carrier from the first major surface and a second set of slits each extending partially into the stretchable carrier from the second major surface.

15. The stretch-releasable adhesive article of claim 1, wherein the pattern of slits includes a hierarchical structure.

16. A method of making a stretch-releasable adhesive tape comprising:
providing a stretchable carrier, the stretchable carrier extending along a first direction and including a first major surface and a second major surface opposite to the first major surface, at least one of the first and second major surfaces of the stretchable carrier being a stretch-releasable adhesive surface; and
providing a pattern of slits distributed on the stretchable carrier, the slits each configured to deform upon a stretch on the stretchable carrier to elongate the stretchable carrier.

17. The method of claim 16, further comprising providing a tab disposed at one end of the stretchable carrier to facilitate a stretch release of the stretch-releasable adhesive article from a substrate surface.

18. The method of claim 17, wherein the tab includes an extension of the stretchable carrier.

19. The method of claim 16, wherein the stretchable carrier includes a polymeric foam, a polymeric film, or a combination thereof.

20. The method of claim 16, wherein the pattern of slits includes an array of slits each extending along a direction substantially perpendicular to the first direction.

21-26. (canceled)
